(19) United States
(12) Patent Application Publication
(10) Pub. No.: US 2010/0201275 A1
(43) Pub. Date: Aug. 12, 2010

(54) LIGHT SENSING IN DISPLAY DEVICE

(76) Inventors: RONALD S. COK, Rochester, NY (US); John W. Hamer, Rochester, NY (US)

Correspondence Address: MORGAN LEWIS & BOCKIUS LLP, 1111 PENNSYLVANIA AVENUE NW, WASHINGTON, DC, 20004, US

(21) Appl. No.: 12/366,832

(22) Filed: Feb. 6, 2009

(51) Int. Cl. H05B 37/02

(52) U.S. Cl. 315/158

(57) ABSTRACT

A method for controlling an OLED display includes providing an OLED device and a controller, measuring and communicating the amount of ambient and emitted OLED light incident upon an array of photosensors distributed over the display area for measuring the incident light, operating the OLED pixels with at least one calibration image and forming an OLED compensation map in response to a first measured incident light, receiving a second incident light measurement and forming an ambient illumination map, receiving and compensating an image and driving the OLED pixels with the compensated image, receiving a third incident light measurement and forming large-area average values and small-area average values, and comparing the large-area average values and the small-area average values to a predetermined criterion, and determining the location of one or more light occlusions or reflections.

### FIELD OF THE INVENTION

The present invention relates to a method for controlling an array of optical sensors in a display device having a substrate with distributed, independent chiplets for controlling a pixel array.

### BACKGROUND OF THE INVENTION

Flat-panel display devices are widely used in conjunction with computing devices, in portable devices, and for entertainment devices such as televisions. Such displays typically employ a plurality of pixels distributed over a substrate to display images. Each pixel incorporates several, differently colored light-emitting elements commonly referred to as sub-pixels, typically emitting red, green, and blue light, to represent each image element. As used herein, pixels and sub-pixels are not distinguished and refer to a single light-emitting element. A variety of flat-panel display technologies are known, for example plasma displays, liquid crystal displays, and light-emitting diode (LED) displays.

Light emitting diodes (LEDs) incorporating thin films of light-emitting materials forming light-emitting elements have many advantages in a flat-panel display device and are useful in optical systems. U.S. Pat. No. 6,384,529 issued May 7, 2002 to Tang et al. shows an organic LED (OLED) color display that includes an array of organic LED light-emitting elements. Alternatively, inorganic materials can be employed and can include phosphorescent crystals or quantum dots in a polycrystalline semiconductor matrix. Other thin films of organic or inorganic materials can also be employed to control charge injection, transport, or blocking to the light-emitting-thin-film materials, and are known in the art. The materials are placed upon a substrate between electrodes, with an encapsulating cover layer or plate. Light is emitted from a pixel when current passes through the light-emitting material. The frequency of the emitted light is dependent on the nature of the material used. In such a display, light can be emitted through the substrate (a bottom emitter) or through the encapsulating cover (a top emitter), or both.

LED devices can comprise a patterned light-emissive layer wherein different materials are employed in the pattern to emit different colors of light when current passes through the materials. Alternatively, one can employ a single emissive layer, for example, a white-light emitter, together with color filters for forming a full-color display, as is taught in U.S. Pat. No. 6,987,355 entitled, “Stacked OLED Display having Improved Efficiency” by Cok. It is also known to employ a white sub-pixel that does not include a color filter, for example, as taught in U.S. Pat. No. 6,919,681 entitled, “Color OLED Display with Improved Power Efficiency” by Cok et al. A design has been taught employing an unpatterned white emitter together with a four-color pixel comprising red, green, and blue color filters and sub-pixels and an unfiltered white sub-pixel to improve the efficiency of the device (see, e.g. U.S. Pat. No. 7,230,594 issued Jun. 12, 2007 to Miller, et al).

OLED display devices are subject to a loss of efficiency and light output as the organic materials age with time and use. This aging is typically in response to the cumulative current passed through the organic materials. A variety of methods for compensating the OLED display for aging are known, including measuring the resistance of the organic material layer, accumulating a record of the cumulative current passed through the OLED materials, and employing a photosensor to measure the actual light output of the organic layers, as described in, for example, U.S. Pat. No. 6,995,519, U.S. Pat. No. 7,161,566, U.S. application Ser. No. 10/962,020, U.S. Pat. 6,320,325, and U.S. Pat. No. 7,321,348.

In general, the image quality of emissive display devices (such as OLED displays) suffers under bright ambient illumination. In such conditions, the displays appear washed out and lacking in color saturation. To some extent this problem can be compensated by detecting the level of ambient illumination and then adjusting the brightness of the display. For example, in a dark environment, a display might be relatively dim, and in a bright environment, the display might be relatively bright, thus saving energy in the dark environment and improving image quality in the bright environment, for example as taught in U.S. Pat. No. 7,026,597, U.S. Pat. No. 6,975,008, and U.S. Pat. No. 7,271,378.

It is also known in the prior art to obtain user feedback with a display by employing touch screens. Touch screens can be implemented with a variety of technologies, for example resistive, capacitive, or inductive touch screens (see, e.g. U.S. Pat. No. 7,081,888). Other touch screens employ optical sensors and rely upon the occlusion of ambient light or the reflection of emitted light to indicate a touch (for example U.S. Pat. No. 7,042,444 and U.S. Pat. No. 7,230,608).

Optical sensors external to a display have been used in the prior art, for example in televisions and personal digital assistants, for many years. Controllers sense the feedback from an external sensor to adjust the brightness of a display. Optical sensors have also been employed within active-matrix circuits associated with individual pixels and used, for example, to compensate OLED pixel aging as described in U.S. Pat. No. 6,489,631 and in LCD devices as described in U.S. Pat. No. 5,831,693. In an article in the Journal of the Society of Information Display, 16/11, 2008 entitled “A touch-sensitive display with embedded hydrogenated amorphous-silicon photodetector arrays”, Park et al describe an LCD with an array of embedded photosensors. For active-matrix backplanes, providing photosensors within the pixel circuits limits the available technology employed to that of the thin-film material. Amorphous silicon is known to unstable over time and low-temperature polysilicon is only available in small sizes and is known to have problems with non-uniformity. The resulting circuits, because large transistors are required for thin-film devices, are themselves large and can limit the aperture ratio of OLED devices. Signal-to-noise ratios can also be limited, especially as the array size increases.

In an LCD application, there is no organic material aging requiring compensation. Furthermore, a transmissive LCD employs a backlight that does not necessarily expose the array of photosensors to emitted light. Therefore, the LCD designs are not adequate for emissive displays such as OLEDs that require material aging compensation.

In an OLED display, the optical sensors can be very closely integrated with the light-emitting element, for example as disclosed in U.S. Pat. No. 6,933,532. U.S. Pat. No. 6,717,560 describes optical sensors distributed over a substrate and intermixed with light-emitting pixels to provide a near-field image capture device. Communicating feedback from such active-matrix circuits to an external controller is difficult, however, since the circuits typically employ thin-film transistors that limit the display resolution and have limited performance.

As described above, optical sensors can be employed in an OLED display to compensate for OLED aging, for ambient illumination, for touch screens, and for near-field image scanning. Each of these applications is described separately. In a device providing all of these features, separate sensors can be employed to avoid confusing the optical measurement for each of these applications. This approach, however, can be expensive, redundant, and wasteful, requiring separate sensors and support circuitry. There is a need, therefore, for an improved optical sensing method that employs fewer optical sensors while providing ambient illumination compensation, aging compensation, near-field image scanning, and optical touch screen capability.

### SUMMARY OF THE INVENTION

In accordance with the present invention, there is provided a method for controlling an OLED display having a substrate and an array of OLED pixels forming a display area and having electrodes formed over the substrate, and a controller for practicing the following steps:

a) measuring and communicating the amount of ambient and emitted OLED light incident upon an array of photosensors distributed over the display area for measuring the incident light;

b) operating the OLED pixels with at least one calibration image and forming an OLED compensation map in response to a first measured incident light;

c) receiving a second incident light measurement, subtracting any light emitted from the OLED pixels from the second incident light measurement, and forming an ambient illumination map;

d) receiving an image, compensating the image with the OLED compensation map and the ambient illumination map, and driving the OLED pixels with the compensated image;

e) receiving a third incident light measurement, subtracting the OLED compensation map from the incident light measurement, forming large-area average values and small-area average values; and

f) comparing the large-area average values and the small-area average values to a pre-determined criterion, and determining the location of one or more light occlusions or reflections.

### ADVANTAGES

The present invention provides an integrated method employing an array of photosensors for ambient illumination compensation, aging compensation, near-field image scanning, and optical touch screen capability in an OLED display device.

### BRIEF DESCRIPTION OF THE DRAWINGS

FIG. 1 is a flow diagram illustrating a method according to an embodiment of the present invention;

FIG. 2A is a flow diagram illustrating a portion of the method according to an embodiment of the present invention;

FIG. 2B is flow diagram illustrating a portion of an alternative method according to an embodiment of the present invention;

FIG. 3A is a flow diagram illustrating a portion of the method according to an embodiment of the present invention;

FIG. 3B is a flow diagram illustrating a portion of the method according to an alternative embodiment of the present invention;

FIG. 4 is a flow diagram illustrating a portion of the method according to an embodiment of the present invention;

FIG. 5A is flow diagram illustrating a scan operation according to an embodiment of the present invention;

FIG. 5B is flow diagram illustrating a multi-color scan operation according to another embodiment of the present invention;

FIG. 6 is a schematic of a display device having a pixel array, a chiplet array, and a controller that practices the flow diagrams set forth above in accordance with the present invention;

FIG. 7 is a partial cross section of a bottom-emitter display device having a chiplet, a pixel, and a photosensor according to an embodiment of the present invention;

FIG. 8 is a partial cross section of a top-emitter display device having a chiplet, a pixel, and a photosensor according to an embodiment of the present invention;

FIG. 9 is a schematic of a chiplet connected to a plurality of pixels according to an embodiment of the present invention;

FIG. 10 is a partial cross section of a bottom-emitter display device having a chiplet with opaque portions according to an embodiment of the present invention; and

FIG. 11 is a schematic of circuitry within a chiplet according to an embodiment of the present invention.

Because the various layers and elements in the drawings have greatly different sizes, the drawings are not to scale.

### DETAILED DESCRIPTION OF THE INVENTION

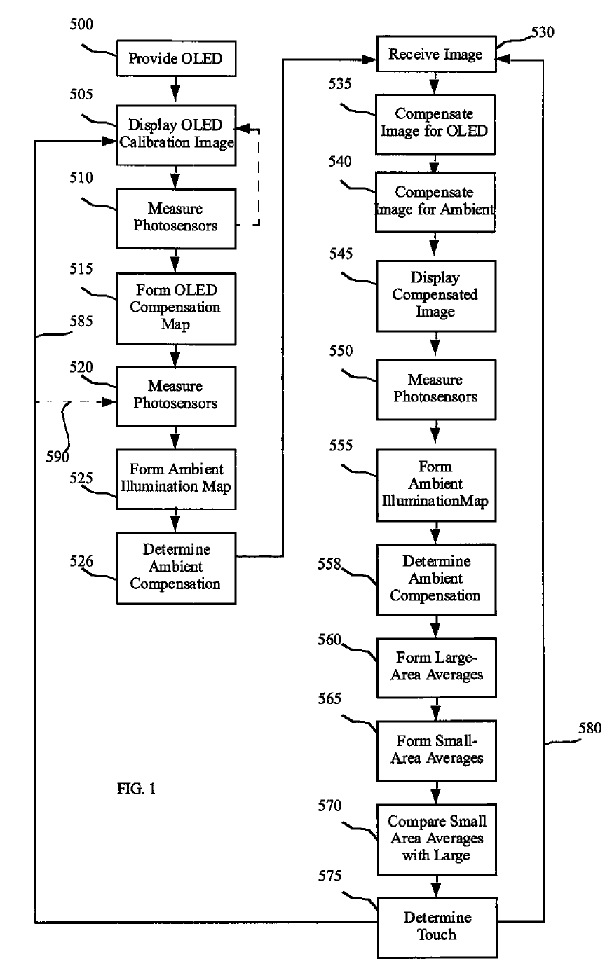

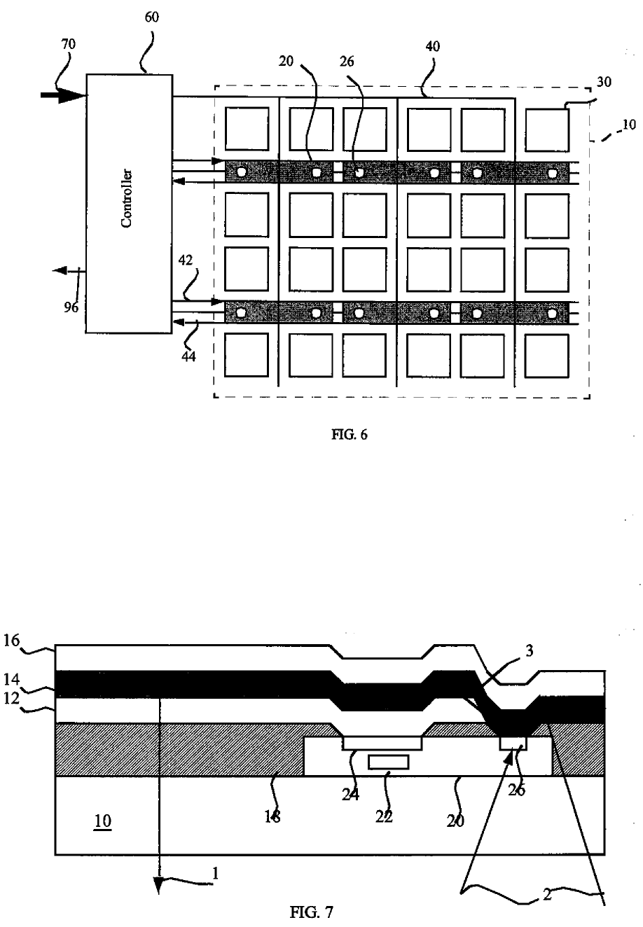

FIG. 1 includes a method for controlling an OLED display that is practiced by the external controller 60 shown in FIG. 6. In one embodiment of the present invention, the method includes providing 500 a substrate, an array of OLED pixels formed on the substrate forming a display area and having electrodes formed over the substrate. An array of photosensors distributed over the display area and supporting circuitry measures and communicates the ambient and emitted OLED light incident upon the photosensors. The OLED pixels are then driven 505 with at least one calibration image, a first incident light measurement made 510 and communicated to an external controller, and an OLED compensation map formed 515. These steps can be done initially in a manufacturing process, e.g. as part of a calibration process. This initial OLED compensation map can provide display non-uniformity correction and include any effects of factory burn-in, if performed on the OLED. The OLED calibration image can include a single image or can include a series of images.

In general, the OLED compensation map refers to a set of functions (typically, one per pixel) that has as input the desired pixel luminance and has as output the compensated pixel luminance that, when sent Through the image processing chain hardware and software, will display the desired pixel luminance. For example, the OLED compensation map for each pixel can be the ratio of the nominal luminance efficiency of a pixel divided by the current estimate of its luminance efficiency. The photosensor measurements will include the response to light from outside the display from both far-field sources and near-field display reflections (which can be stored in the ambient illumination map) and, in addition, the photosensor measurements can also include the response to light emitted inside the display that reaches the photosensor by way of internal reflection. In order to form the OLED compensation map, the photosensor measurements should be corrected by first subtracting the estimated ambient light contribution for each photosensor stored in the ambient illumination map.

The OLED calibration image can include a uniform, flat-field image or can include a series of separate images, for example each image can prescribe emission from only a subset, or only one, light-emitter. Moreover, each emitter can be driven at a variety of luminance levels. For example, a series of flat-field images at luminance levels ranging from dim to bright can be employed. Once the photosensor measurements are complete, the OLED compensation map can be formed 515. Note that the compensation map can include multiple maps at different luminance levels or under different conditions (e.g. temperature). This OLED compensation map can be used to form a correction for images to be displayed on the OLED device. For example, if a flat field image is actually displayed with non-uniformities (bright or dim spots or lines), an image can be correspondingly processed to compensate for the non-uniformity to present the image on the display as desired. For example, if din spots are present, the image can be processed in those spots to be brighter. If bright spots are present, the image can be processed in those spots to be dimmer. Such non-uniformities in an OLED display can result from non-uniform organic material deposition or non-uniformities in the transistor characteristics of an active-matrix display. Over time and use, the non-uniformities can change, and the OLED compensation map can be changed to match the display characteristics.

In a second step that can be performed after, before, or at the same time as the formation of the OLED compensation map, depending on the control of the OLED pixels, a second incident light measurement is made 520 and employed to form 525 an ambient illumination map. The ambient illumination map is a record of the ambient light falling on the display surface, as recorded by the photosensors. Generally, light from both the ambient environment and the OLED emitters are incident on the photosensors. The ambient illumination map can be analyzed to determine a single representative value for the estimated average ambient light, for example by averaging the ambient illumination map values in areas where no touch is suspected in order to determine 526 an ambient compensation parameter that can, in turn, be employed to process an image for display. For example, if the average ambient illumination is high, an image for display on the OLED device can be made brighter to improve the appearance of the image. If the average ambient illumination is low, an image for display on the OLED device can be made dimmer to save power or otherwise make the image-viewing environment more comfortable for a viewer.

In a third step, an image for display can be received 530, compensated 535 for non-uniformities and aging in the OLED with the OLED compensation map, compensated 540 for ambient illumination with the ambient illumination map, and displayed 545.

In a fourth step, the ambient illumination map is analyzed to determine areas where a touch has occurred. A third incident light measurement is made 550, and processed to form an ambient illumination map 555 for example by subtracting any displayed image and ambient illumination. An overall ambient compensation can then be determined 558. In one alternative embodiment of the present invention, the OLED pixels are turned off for the incident light measurement so that the correction for the internally reflected and emitted light is unnecessary (or subtracts zero or a very small value).

An example process for determining the location of a touch is described as follows. The resulting image can be normalized as desired. The normalized image is then processed to form 560 large-area average values and to form 565 small-area average values. The large-area average values represent the ambient illumination on the display over areas much larger than the areas in which a touch is to be located. The small-area average values represent areas of the approximate expected size of a touch detection. The large and small area average values are compared 570 and the location of one or more light occlusions or reflections determined 575 and communicated. Many other ways of detecting and analyzing the variations in the ambient illumination map in order to determine a touch can be employed. Each time the ambient illumination map is formed 555, the parameters controlling the ambient compensation are determined 558 and updated based on the values of the ambient illumination map outside the touch areas.

The process can be repeated 580 for multiple images and for multiple touch tests. Since the process of receiving an image, compensating the image, displaying the image, and detecting a touch is repeated, either can be performed first, that is the steps of 530 to 545 can be done after the steps of 550 to 575. Periodically, for example every second, a new ambient illumination map can be optionally formed 590 by repeating steps 520 and 525. Alternatively, the new ambient illumination map can be created as a part of the process in which touch sensing is performed.

The ambient illumination map can be updated as necessary, for examples every second. In various embodiments of the present invention, the ambient illumination map can be updated often enough to accommodate changes in physical location or illumination or touch cycles.

The photosensors can be provided in one or more chiplets mounted on the substrate in the display area.

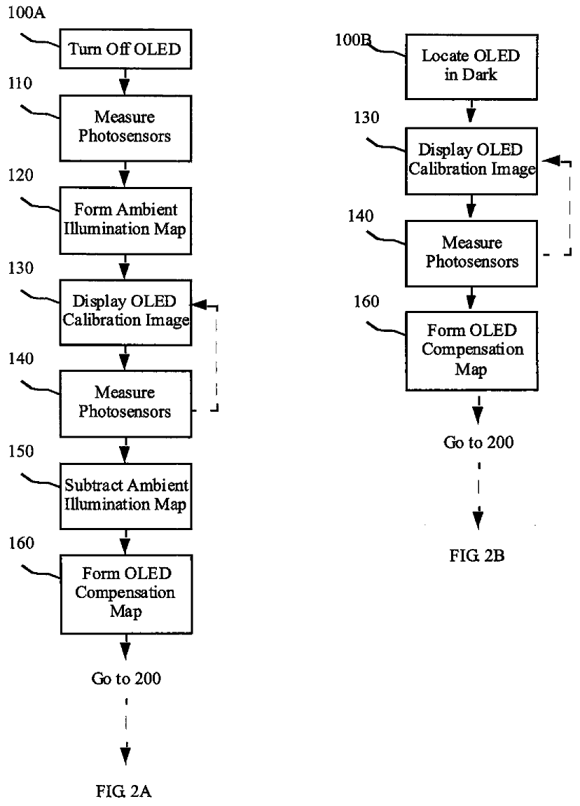

Periodically, the OLED compensation map can be updated 585 to correct for OLED aging or for changes in operating conditions, for example temperature. For example, whenever the display is powered on or off, or at pre-determined times, or after a predetermined amount of use, the OLED display can be recalibrated by repeating the steps 505 through 515 to form a new OLED compensation map. When forming successive OLED compensation maps to recalibrate the display, the methods illustrated in either FIG. 2A or FIG. 2B can be employed, as described below.

The general steps described in FIG. 1 can be implemented in different ways in various embodiments of the present invention. For example, referring to FIG. 2A, somewhat alternative steps can be employed to those of 505 to 525. The OLED pixels can be turned off 100A (for example for one frame time) and the photosensor values measured 110. These measurements can be employed to form 120 an ambient illumination map. Since this is done with the OLEDs turned off, there will be no contribution to the photosensor signal from near-filed reflections of OLED-emitted light or reflected OLED-emitted light. In general, the ambient illumination map is the photosensor measurements corrected for any OLED emissions or reflections within the display.

Both the OLED emitters and the photosensors operate very quickly, that is much faster than a typical frame time in a video sequence. Hence, these steps can be performed in a single frame cycle or within a portion of a single frame cycle, reducing the visibility of the operation to a viewer.

One or more OLED calibration images can be displayed 130 on the OLED display and photosensor measurements taken 140. These measurements represent the incident light of both the ambient environment and the OLED pixel emission. The ambient illumination map is then subtracted 150, leaving only the emission of the OLED pixels that are then employed to form 160 an OLED compensation map. If multiple calibration images are employed, the measurements of each image can be corrected with the ambient illumination map. A separate ambient illumination map can be employed with each calibration image, if desired. Such a calibration process can be performed while the display is in use or employed by a customer.

In an alternative method according to an embodiment of the present invention and illustrated in FIG. 2B, the OLED can be located 100B in the dark so that no ambient illumination is present. Steps 130 to 160 can then be performed to form the OLED compensation map with less error, since the ambient illumina is known to be zero. Hence, no ambient illumination map need be formed. This process is preferably done in a manufacturing facility where control over the display device environment is readily provided. Alternatively, the ambient illumination map can be employed to detect a dark surround and the process of FIG. 2B performed then.

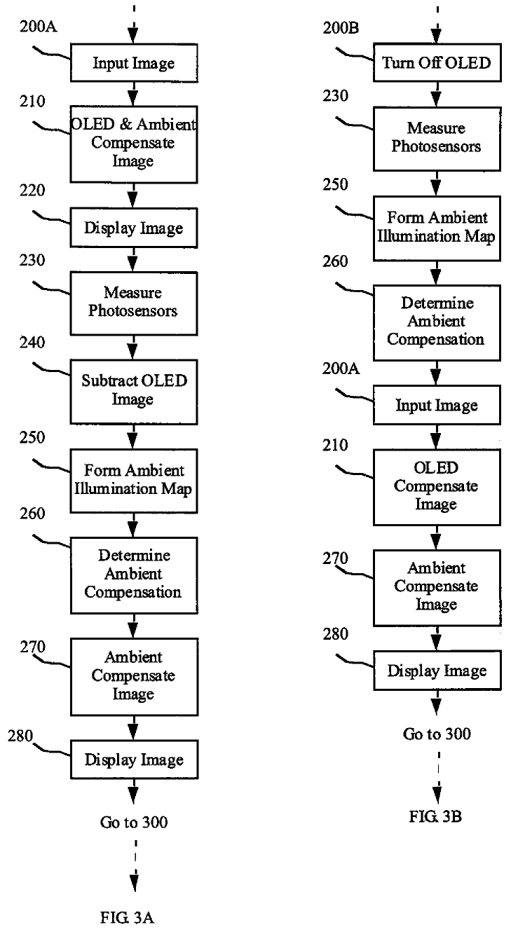

Referring to FIGS. 3A and 3B, the display can be operated to display images for a viewer. As illustrated in FIG. 3A, an image is first input 200A, compensated 210 using the OLED compensation and ambient illumination maps, and displayed 220. A photosensor measurement is taken 230, the component of the measurement from the OLED image subtracted 240, and an ambient illumination map formed 250. The ambient illumination map can be used to determine 260 an ambient compensation level that can then be applied to compensate 270 the image for ambient illumination, and the compensated image displayed 280. In an alternative embodiment, referring to FIG. 3B, the OLED pixels can first be turned off, 200B, the photosensor measurement made 230, and employed to form 250 an ambient illumination map. Since the OLED is off, no OLED pixel contribution to the photosensor measurement need be subtracted from the photosensor measurement. From the ambient illumination map, an ambient compensation can be determined 260. An image can then be input 200A (or the image can be input at any earlier step), compensated 210 with the OLED compensation and ambient illumination maps, compensated 270 with the ambient illumination map, and displayed 280.

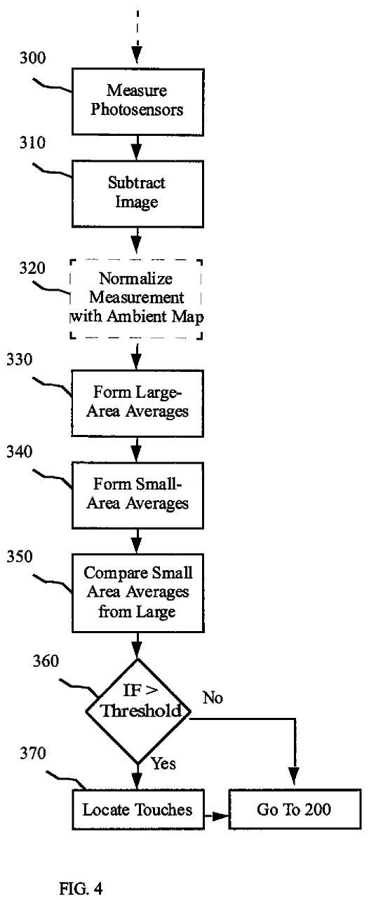

An example of a method for determining touches according to an embodiment of the present invention is shown in FIG. 4. A photosensor measurement can be made 300 and the OLED image contribution subtracted 310. Alternatively, the measurement can be made while the OLEDs are turned off (e.g. as in step 200B). After the ambient illumination map is formed, the map can be processed 320 as desired (for example to normalize the ambient illumination map to a standard brightness and range, and gray-scale curve. Large-area averages are formed 330 and small-area averages are formed 340 (in any order) for locations of interest on the display (possible over the entire display or only subsets of the display). The corresponding values for each area are compared 350. In particular, shape detection and edge detection algorithms can be employed on the small-area average values to detect light occlusions or reflections having a shape and size resembling that of a touching implement, which can be a stylus or finger. The shapes are distinguished from the background of the large-area average values. If shapes are detected and are clear enough to exceed 360 a pre-determined threshold, the shapes (touch) can be located 270. Note that multiple touches can be determined at the same time.

Touches can be detected in at least two ways. In one method, the ambient illumination map contains dark spots (darker than the ambient large-area average surround) of a shape and size indicating one or more touches. This method is problematic, however, if the device is operated in the dark or if the ambient environment naturally provides such dark spots (e.g. shadows). In an alternative embodiment, the OLED pixels can emit light that is reflected off of a touching instrument (e.g. stylus or finger), providing a bright spot in the ambient illumination map. In one such design, for example, the bright spot can be formed by displaying a normal image and simultaneously sensing light using the photosensors.

In a further embodiment, when the portion of the display touched is dark (e.g. a dark image or image portion is displayed), the display can preferably display an image to illuminated a touching implement and detect relatively bright reflections from the touching implement. The touch sensing is done only during the illumination time and is used to increase the touch signal compared to the background ambient light. The illuminating image can be, for example, a flat field over the entire image or a portion of the image. If a portion of an image is used, the remainder of the image can be the normally desired output image. The portion of the image can be chosen as an area where a touch is expected, suspected, or desired. The illuminating image can be very brief to avoid disturbing a viewer (e.g. one video frame). Alternatively, the illuminating image can display for much less than one frame time, and the remainder of the frame time can be employed to display the normally desired output image.

In a further embodiment of the present invention, the image displayed in the remainder of the frame time can be adjusted so that the total light emitted over the frame time matches the original desired image value. For example, if two pixels of an image are desired to display a code value of 150 and 200, respectively, for a frame cycle, an illuminating exposure of 100 can be displayed for one tenth of a frame cycle and the photosensor measurement made during that time. For the remainder of the frame cycle, one pixel is driven at a code value of 155 and the other at 211 (assuming a linear response on the part of the viewer). Since the viewer's eye will integrate the emitted light over the frame time, the change in luminance within the frame cycle will not be detectable. In a second example, two pixels of an image are desired to display a code value of 50 and 75, respectively, for a frame cycle. Again, an illuminating exposure of 100 can be displayed for one tenth of a frame cycle and the photosensor measurement made during that time. For the remainder of the frame cycle, one pixel is driven at a code value of 44 and the other at 72. Only if the desired pixel emission is less than 10 will an emission difference be necessary. In that case, either a shorter interval (less than one tenth of a frame cycle) or a dimmer flat field (less than 100) can be employed, or the emission difference ignored.

The chiplets in the backplane can control and coordinate both the OLED illuminating image and the capture of the photosensor signals. The OLED emission response characteristic is fast enough to respond to microsecond signals and the CMOS circuits in the chiplet can provide such control signals. Within the CMOS chiplet, the light sensor can be integrated over a similarly short and precise time period, and the accumulated photo charge can be amplified locally within the chiplet to prevent dark current noise from dominating the image. The use of crystalline silicon chiplets having excellent mobility enables the use of fine and dense integrated circuit geometries providing a high level of sophisticated signal control, acquisition, and processing. In turn, such capabilities provide a high level of functionality within the display.

In yet a further embodiment of the present invention, the illuminating image can be temporally coded to avoid any temporal ambient effects such as might be present from variable illumination in the ambient surround (e.g 60 Hz flicker in a fluorescent light). By repeating the flat-field test multiple times at various durations, brightness, and frequencies, the measured photosensor results can remove any such confounding factor. Furthermore, a subset of pixels can be illuminated to test only portions of the display for touches, if further corroboration is necessary.

In a further embodiment of the present invention, a light-emitting stylus can be employed to expose the photosensors to indicate a touch.

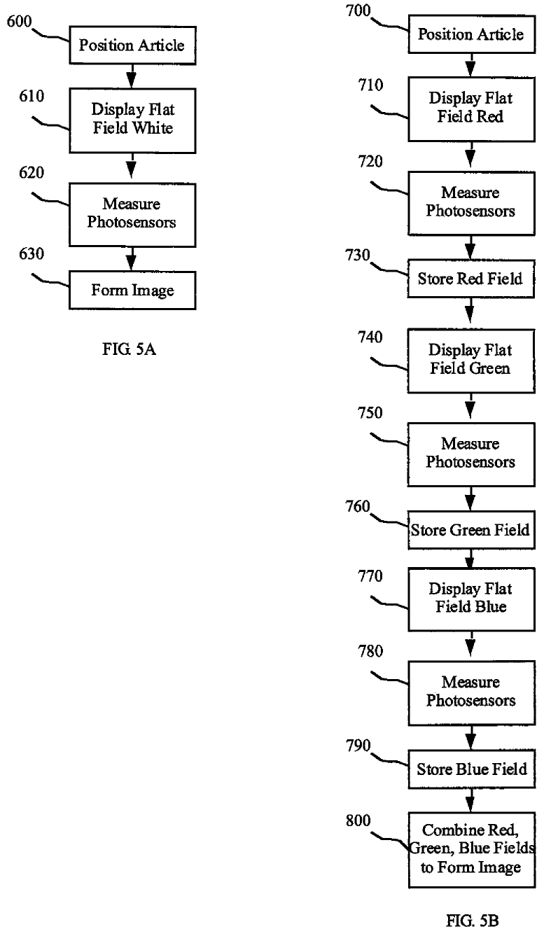

In yet another embodiment of the present invention, the OLED display can be used to scan a near-field image, for example a document placed over the display or disposed near the display. Referring to FIG. 5A, an article is positioned 600 over the display. The display displays 610 a flat-field white image. The white light reflected from the article incident on the photosensors is measured 620 by the photosensors and the result used to form 630 a black and white image. Referring to FIG. 5B, the process can be repeated multiple times with different color flat fields (for a multi-color display). In this case, the article is positioned 700 over the display, a red flat field displayed 710, the red light incident on the photosensors measured 720 and stored 730, a green flat field displayed 740, the green light incident on the photosensors measured 750 and stored 760, and a blue flat field displayed 770, the blue light incident on the photosensors measured 780 and stored 790. The three color images can then be combined 800 to form a multi-color image of the article. The steps of 5B can be repeated to include the white flat field as described with respect to FIG. 5A and the multi-color image processed to include the incident light measured in response to the white field. The article can also be exposed to secondary colors, for example yellow, cyan, and magenta, and the response measured by the photosensor array.

Referring to FIG. 6, the method of the present invention as shown in flow diagrams FIGS. 1-5B can be implemented in an OLED display by using external controller 60. Controllers 60 are well known in the art and can include a microprocessor with an appropriate program, a field-programmable gate array or an application-specific integrated circuit. The OLED display includes a substrate 10, an array of OLED pixels 30 formed on the substrate 10, and an array of chiplets 20 located over the substrate 10, each chiplet 20 connected to at least one electrode of two or more OLED pixels 30, each chiplet 20 including an independently-accessible photosensor 26 exposed to ambient illumination and light emitted from at least one OLED pixel 30 and a circuit for measuring and communicating the amount of light incident upon the photosensor 26, and an external controller 60 for controlling the OLED pixels 30 with the array of chiplets 20 and for receiving the photosensor incident light measurement.

Referring to FIG. 11, in one embodiment of the present invention, the controller 60 includes an OLED compensation circuit 81 receiving an image signal 70. The OLED compensated signal is then corrected for ambient illumination using circuit 83. A switch 93 determines the controller function as will be discussed further below. A driving circuit 80 operates the OLED pixels through signals carried on buss 42 with at least one calibration image, for example stored in memory 84. The switch 93 can be a logical switch or a state machine.

A circuit 82 receives a first incident light measurement from signals carried on a buss 44. The incident light measurement can be corrected for internally reflected OLED emissions included in the incident light measurement with circuit 86. Image output and the resulting ambient illumination map are determined and stored, for example in a memory 88. The ambient illumination map is employed to determine touches with circuit 90 that are output with touch signal 96. The ambient illumination map can also be employed as a scanner and the scanned signal 98 output. Once touches are determined with circuitry 90, the ambient illumination map can be updated with circuitry 92 to provide an ambient illumination map corrected for a touching implement and stored in a memory 89. The corrected ambient illumination map can be used to calculate an ambient light compensation with circuit 94 that in turn, drives the ambient compensation circuit 83. The touch signal circuitry can also be employed to determine illumination images with circuitry 91 if illumination is necessary.

The OLED compensation map is updated with the incident light measurement in circuitry 95 and the OLED compensation map can be stored in a memory 97 that is employed by the COLED compensation circuit.

The controller 60 has been described above in terms of circuits, in one embodiment. As is well known in the computing industry, however, a state machine or a computing device with a stored program can also be employed to implement the controller 60.

The controller 60 receives input image signals 70 for display on the OLED display and communicates to the chiplet array through a buss 42 and receives signals from the photosensor array through a signal line 44.

Referring to FIG. 7, in a more detailed side view of the chiplet 20 and OLED pixel structure, the substrate 10 has a chiplet 20 adhered over the substrate 10. The chiplet 20 includes circuitry 22 to drive a pixel 30 and has a connection pad 24 formed on the surface. The connection pad connects to a first electrode 12 on which is formed one or more layers 14 of light-emitting organic material. A second electrode 16 is formed over the one or more layers 14 of light-emitting organic material. The OLED structure can be either top- or bottom-emitting, the substrate either transparent or opaque, the first electrode 12 either transparent or reflecting, and the second electrode 16 either reflecting or transparent to complement the first electrode 12. A photosensor 26 is located in the chiplet 20. A patterned dielectric layer 18 is located over the substrate to planarize the substrate surface and the chiplet 20 and to provide access to the connection pad 24 and provide an optical path to the photosensor from the emitted light 1,3, and ambient light 2.

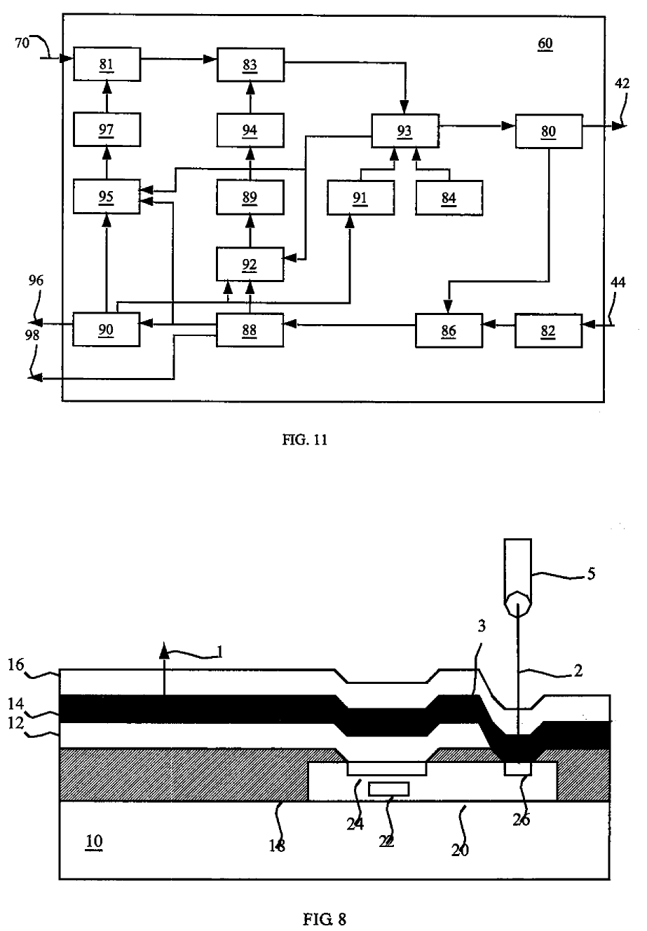

FIG. 7 is a bottom-emitter embodiment of the present invention. FIG. 8 illustrates a top-emitter design and illustrates a light-emitting stylus 5 for providing stimulation to the photosensors.

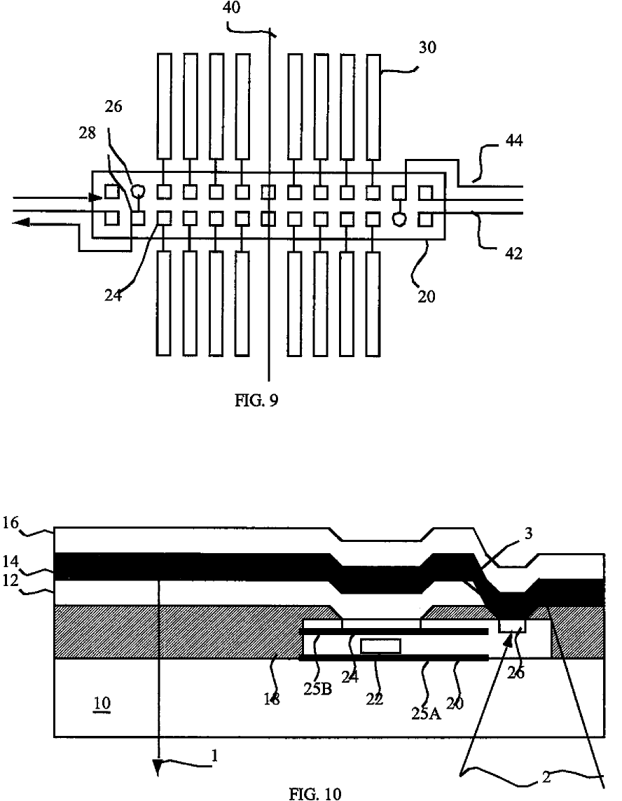

FIG. 9 illustrates a single chiplet 20 having a plurality of connection pads for driving pixels 30. A photosensor 26 is formed in the chiplet 20, together with a control and communication circuit 22. Busses 40, 42, 44 connected to connection pads 24 assist in communication and control. FIG. 10 illustrates the use of opaque layers 25A located between the circuits for driving the OLED pixels and the substrate or an opaque layer 25B located between the circuits for driving the OLED pixels and the OLED pixels. Such layers can be formed of metal or black matrix material (e.g. black resin or black metal oxides).

To facilitate control of the various modes of the display, the controller can include a switch 93 having an operation position, a calibration position, a scan position, and a baseline position for controlling the OLED pixel luminance independently of the photosensor measurement and communication. The switch can be a logical switch, for example digital state machine that provides digital circuitry responsive to inputs and providing output control signals representative of the switch state.

An active-matrix OLED display device employing chiplets has been made and evaluated. Photosensitive circuitry on the chiplet has demonstrated light sensitivity to ambient light. Touch sensitivity in the chiplet and the OLED display has been demonstrated by using a finger to occlude ambient light and increase reflected OLED-emitted light. Tests show a high degree of sensitivity, uniformity, and stability. Furthermore, the design is scaleable to large substrate sizes. Photosensors designed within crystalline-silicon-substrate chiplets are very small and additional circuitry to improve the signal and reduce noise can be included in the chiplet. There is no limitation on the number of photosensors in the array, and cross-talk can be limited. Expensive support chips (A/D convertors, charge amplifiers, line buffers, etc.) can be avoided. Furthermore, multi-touch capability is inherent, and the various functions discussed are readily controlled and can provide acceptable functional performance.

Each chiplet 20 can include circuitry 22 for controlling the pixels 30 to which the chiplet 20 is connected through connection pads 24. The circuitry 22 can include storage elements that store a value representing a desired luminance for each pixel 30 to which the chiplet 20 is connected in a row or column, the chiplet 20 using such value to control either the first or second electrodes to activate the pixel 30 to emit light. The chiplets 20 can be connected to an external controller 60 through a buss 42. The buss 42 can be a serial, parallel, or point-to-point buss and can be digital or analog. The buss 42 is connected to the chiplets to provide signals from the controller 60. More tan one buss 42 separately connected to one or more controllers 60 can be employed. The busses 42 can supply a variety of signals, including timing (e.g. clock) signals, data signals, select signals, power connections, or ground connections. The signals can be analog or digital, for example digital addresses or data values. Analog data values can be supplied as charge. The storage elements can be digital (for example comprising flip-flops) or analog (for example comprising capacitors for storing charge).

The controller 60 can be implemented as a chiplet and affixed to the substrate 10. The controller 60 can be located on the periphery of the substrate 10, or can be external to the substrate 1O and comprise a conventional integrated circuit.

According to various embodiments of the present invention, the chiplets 20 can be constructed in a variety of ways, for example with one or two rows of connection pads 24 along a long dimension of a chiplet 20. The interconnection busses 42 can be formed from various materials and use various methods for deposition on the device substrate. For example, the interconnection busses 42 can be metal, either evaporated or sputtered, for example aluminum or aluminum alloys. Alternatively, the interconnection busses can be made of cured conductive inks or metal oxides. In one cost-advantaged embodiment, the interconnection busses 42 are formed in a single layer.

The present invention is particularly useful for multi-pixel device embodiments employing a large device substrate, e.g. glass, plastic, or foil, with a plurality of chiplets 20 arranged in a regular arrangement over the device substrate 10. Each chiplet 20 can control a plurality of pixels 30 formed over the device substrate 10 according to the circuitry in the chiplet 20 and in response to control signals. Individual pixel groups or multiple pixel groups can be located on tiled elements, which can be assembled to form the entire display.

According to the present invention, chiplets 20 provide distributed pixel control elements over a substrate 10. A chiplet 20 is a relatively small integrated circuit compared to the device substrate 10 and includes a circuit 22 including wires, connection pads, passive components such as resistors or capacitors, or active components such as transistors or diodes, formed on an independent substrate 28. Chiplets 20 are separately manufactured from the display substrate 10 and then applied to the display substrate 10. The chiplets 20 are preferably manufactured using silicon or silicon on insulator (SOI) wafers using known processes for fabricating semiconductor devices. Each chiplet 20 is then separated prior to attachment to the device substrate 10. The crystalline base of each chiplet 20 can therefore be considered a substrate 28 separate from the device substrate 10 and over which the chiplet circuitry 22 is disposed. The plurality of chiplets 20 therefore has a corresponding plurality of substrates 28 separate from the device substrate 10 and each other. In particular, the independent substrates 28 are separate from the substrate 10 on which the pixels 30 are formed and the areas of the independent, chiplet substrates 28, taken together, are smaller than the device substrate 10. Chiplets 20 can have a crystalline substrate 28 to provide higher performance active components than are found in, for example, thin-film amorphous or polycrystalline silicon devices. Chiplets 20 can have a thickness preferably of 100 um or less, and more preferably 20 um or less. This facilitates formation of the adhesive and planarization material 18 over the chiplet 20 that can then be applied using conventional spin-coating techniques. According to one embodiment of the present invention, chiplets 20 formed on crystalline silicon substrates are arranged in a geometric array and adhered to a device substrate (e.g. 10) with adhesion or planarization materials. Connection pads 24 on the surface of the chiplets 20 are employed to connect each chiplet 20 to signal wires, power busses, and OLED electrodes (16, 12) to drive pixels 30. Chiplets 20 can control at least four pixels 30.

Since the chiplets 20 are formed in a semiconductor substrate, the circuitry of the chiplet can be formed using modern lithography tools. With such tools, feature sizes of 0.5 microns or less are readily available. For example, modern semiconductor fabrication lines can achieve line widths of 90 nm or 45 nm and can be employed in making the chiplets of the present invention. The chiplet 20, however, also requires connection pads 24 for making electrical connection to the wiring layer provided over the chiplets once assembled onto the display substrate 10. The connection pads 24 are sized based on the feature size of the lithography tools used on the display substrate 10 (for example 5 um) and the alignment of the chiplets 20 to the wiring layer (for example ±5 um). Therefore, the connection pads 24 can be, for example, 15 um wide with 5 um spaces between the pads. This means that the pads will generally be significantly larger than the transistor circuitry formed in the chiplet 20.

The pads can generally be formed in a metallization layer on the chiplet over the transistors. It is desirable to make the chiplet with as small a surface area as possible to enable a low manufacturing cost

By employing chiplets with independent substrates (e.g. comprising crystalline silicon) having circuitry with higher performance than circuits formed directly on the substrate (e.g. amorphous or polycrystalline silicon), a device with higher performance is provided. Since crystalline silicon has not only higher performance but much smaller active elements (e.g. transistors), the circuitry size is much reduced. A useful chiplet can also be formed using micro-electro-mechanical (MEMS) structures, for example as described in “A novel use of MEMS switches in driving AMOLED”, by Yoon, Lee, Yang, and Jang, Digest of Technical Papers of the Society for Information Display, 2008, 3.4, p. 13.

The device substrate 10 can comprise glass and the wiring layers made of evaporated or sputtered metal or metal alloys, e.g. aluminum or silver, formed over a planarization layer (e.g. resin) patterned with photolithographic techniques known in the art. The chiplets 20 can be formed using conventional techniques well established in the integrated circuit industry.

The present invention can be employed in devices having a multi-pixel infrastructure. In particular, the present invention can be practiced with LED devices, either organic or inorganic, and is particularly useful in information-display devices. In a preferred embodiment, the present invention is employed in a flat-panel OLED device composed of small-molecule or polymeric OLEDs as disclosed in, but not limited to U.S. Pat. No. 4,769,292, issued Sep. 6, 1988 to Tang et al., and U.S. Pat. No. 5,061,569, issued Oct. 29, 1991 to VanSlyke et al. Inorganic devices, for example, employing quantum dots formed in a polycrystalline semiconductor matrix (for example, as taught in US Publication 2007/0057263 by Kahen), and employing organic or inorganic charge-control layers, or hybrid organic/inorganic devices can be employed. Many combinations and variations of organic or inorganic light-emitting displays can be used to fabricate such a device, including active-matrix displays having either a top- or a bottom-emitter architecture.

The invention has been described in detail with particular reference to certain preferred embodiments thereof but it should be understood that variations and modifications can be effected within the spirit and scope of the invention.

### PARTS LIST

1 emitted light ray
2 ambient light ray
3 emitted light ray
5 light-emitting stylus
10 substrate
12 first electrode
14 layer of light-emissive organic material
16 second electrode
18 planarization layer
20 chiplet
22 circuitry
24 connection pad
25A, 25B opaque layers
26 photosensor
28 chiplet substrate
30 pixel
40, 42, 44 buss signals
60 controller
70 input image signals
80 driving circuit
81 OLED compensation circuit
82 receiving circuit
83 ambient compensation circuit
84 memory circuit
86 emission correction circuit
88 ambient illumination map memory
89 corrected ambient illumination map memory
90 touch detection circuit
91 illumination circuitry
92 corrected ambient illumination circuitry
93 switch
94 determination circuit
95 OLED compensation update circuitry
96 touch signal
97 OLED compensation map memory
98 scan signal
100A Turn off OLED step
100B Locate OLED in dark step
110 Photosensor measurement step
120 Form ambient illumination map step
130 Display OLED calibration step
140 Photosensor measurement step
150 Subtract ambient step
160 Form OLED compensation map step
200A Input image step
200B Turn off OLED step
210 OLED and ambient compensate image step
220 Display image step
230 Photosensor measurement step
240 Subtract OLED image step
250 Form ambient illumination map step
260 Determine ambient compensation step
270 Ambient compensate image step
280 Display image step
300 Photosensor measurement step
310 Subtract image step
320 Normalize ambient illumination map step
330 Form large-area averages step
340 Form small-area averages step
350 Compare step
360 Determine step
370 Locate step
500 Provide OLED step
505 Display OLED calibration image step
510 Photosensor measurement step
515 Form OLED compensation map step
520 Photosensor measurement step
525 Form ambient illumination map step
526 Determine ambient compensation step
530 Receive image step
535 Compensate image for OLED step
540 Compensate image for ambient step
545 Display compensated image step
550 Photosensor measurement step
555 Form ambient illumination map step
558 Determine ambient compensation step
560 Form large-area average values step
565 Form small-area average values step
570 Compare step
575 Determine touch step
580 Repeat step
585 Repeat step
590 Repeat step
600 Position Article
610 Display Flat Field White Image
620 Measure Photosensors
630 Form Image
700 Position Article
710 Display Flat Field Red
720 Measure Photosensor
730 Store Red Field
740 Display Flat Field Green
750 Measure Photosensor
760 Store Green Field
770 Display Flat Field Blue
780 Measure Photosensor
790 Store Blue Field
800 Combine Red, Green, Blue Fields

1. A method for controlling an OLED display having a substrate and an array of OLED pixels forming a display area and having electrodes formed over the substrate, and a controller for practicing the following steps:
a) measuring and communicating the amount of ambient and emitted OLED light incident upon an array of photosensors distributed over the display area for measuring the incident light;
b) operating the OLED pixels with at least one calibration image and forming an OLED compensation map in response to a first measured incident light;
c) receiving a second incident light measurement, subtracting any light emitted from the OLED pixels from the second incident light measurement, and forming an ambient illumination map;
d) receiving an image, compensating the image with the OLED compensation map and the ambient illumination map, and driving the OLED pixels with the compensated image;
e) receiving a third incident light measurement, subtracting the OLED compensation map from the incident light measurement, forming large-area average values and small-area average values; and
f) comparing the large-area average values and the small-area average values to a pre-determined criterion, and determining the location of one or more light occlusions or reflections.

2. The method of claim 1, further including providing the photosensor in one or more chiplets mounted on the substrate in the display area.

3. The method of claim 1, wherein step b) includes displaying a flat-field, iteratively operating separate OLED pixels and measuring the incident light at each iteration with each photosensor, or driving the OLED pixels at a plurality of OLED pixel luminance levels.

4. The method of claim 1, wherein step b) includes forming the OLED compensation map when the OLED display is in a dark environment.

5. The method of claim 1, wherein step b) includes turning off the OLED pixels, measuring the incident light a first time, forming an ambient illumination map, displaying the OLED calibration image, measuring the incident light a second time, and subtracting the ambient illumination map from the second incident light measurement.

6. The method of claim 1, wherein step c) includes receiving an image, compensating the image with the OLED compensation map to form a compensated image, displaying the compensated image, measuring the incident light, and subtracting the compensated image from the measured incident light.

7. The method of claim 1, wherein step c) includes turning off the OLED pixels and measuring the incident light.

8. The method of claim 1, wherein the small-area average values are smaller than the large-area average values and ambient light is used to detect light occlusion by an implement.

9. The method of claim 1, wherein the small-area average values are larger than the large-area average values and further including detecting OLED-emitted light reflected from an implement.

10. The method of claim 9, wherein the OLED-emitted light is an image or a flat-field image displayed on at least a portion of the display.

11. The method of claim 10, wherein the flat-field image is displayed for less than a frame cycle and the image displayed for the remainder of the frame cycle is adjusted so that emission over the entire frame cycle is the same as the emission required for the image.

12. The method of claim 11, wherein the flat-field image is displayed multiple, separate times.

13. The method of claim 12, wherein the multiple, separate times are for different durations, or at different brightness levels, or at different frequencies.

14. The method of claim 1, wherein step f) includes determining a plurality of locations.

15. The method of claim 1, former comprising driving the OLEDs with a white, red, green, or blue flat-field, disposing an object near the display, and measuring the incident light reflected from the object, and processing the measurements to form an image of the object.

16. The method of claim 15, farther comprising iteratively driving the OLEDs with differently colored flat-field images to form a color image.
